(19) United States
(12) Patent Application Publication
(10) Pub. No.: US 2011/0226809 A1
(43) Pub. Date: Sep. 22, 2011

(54) POURING DEVICE

(76) Inventor: Michel MALO, St-Ambroise de Kildare (CA)

(21) Appl. No.: 12/890,127

(22) Filed: Sep. 24, 2010

(30) Foreign Application Priority Data
Mar. 22, 2010 (CA) 2697003

(51) Int. Cl. B65D 47/38; B67D 7/06

(52) U.S. Cl. 222/83.5; 222/89

(57) ABSTRACT

There is provided a pouring device for use with a pouch containing a liquid comprising. For example, the pouring device can comprise a first closing mechanism and a second closing mechanism. The first closing mechanism is effective for allowing or preventing passage of a fluid from a first chamber to the outside of the device. The second closing mechanism is effective for allowing or preventing passage of a fluid from the first chamber to a second chamber that is adapted to be in fluid flow communication with the pouch.

### CROSS-REFERENCE TO RELATED APPLICATION

The present application claims priority on Canadian patent application No. 2,697,003 filed on Mar. 22, 2010, which is hereby incorporated by reference in its entirety.

### FIELD OF THE DISCLOSURE

The present disclosure relates to the field of pouring devices for use in combination with a pouch comprising a liquid. In particular, the disclosure relates to pouring devices and a kit for pouring liquids.

### BACKGROUND OF THE DISCLOSURE

It is well known that the packaging industry tends to use plastic bags for containing and transporting goods such as foods, produces, powders, ice and chemicals. These plastic bags or pouches consist of a flexible packaging made of a thin, supple, plastic film. After being filled with the goods in question, these bags or pouches are heat sealed together, bonded with adhesives or stitched. This type of packaging is appealing to the industry since it is easily sterilized and can therefore be reused. Moreover, this type of packaging is environmentally friendly. Indeed, plastic bags usually use less material than comparable boxes, cartons, or jars, thus are often considered as “reduced or minimized packaging”. Depending on the construction, plastic bags can be well suited for plastic recycling.

In the food industry, these bags or pouches are often used to package liquids such as water, milk, juices, wine or sauces. In order to have access to the enclosed product, the user will often cut one of the bag's corners. This method creates a permanent opening, which exposes the remaining liquid to the ambient air. Such exposition creates a risk of bacterial contamination or oxidation of the enclosed liquid.

### SUMMARY OF THE DISCLOSURE

According to one aspect there is provided a pouring device for use with a pouch containing a liquid comprising:

a housing comprising walls defining a first chamber adapted to receive a liquid and a second chamber adapted to receive a liquid, the first chamber being adapted to be in fluid flow communication with the second chamber and the second chamber being adapted to be in fluid flow communication with the pouch;

a first closing mechanism effective for allowing passage of a fluid from the first chamber to the outside of the device when being in an open position and being effective for preventing passage of a fluid from the first chamber to the outside of the device when being in a closed position; and

a second closing mechanism effective for allowing passage of a fluid from the first chamber to the second chamber when being in an open position and being effective for preventing passage of a fluid from the first chamber to the second chamber when being in a closed position.

According to another aspect there is provided a pouring device for use with a pouch containing a liquid comprising:

a housing comprising walls defining a first chamber adapted to receive a liquid and a second chamber adapted to receive a liquid, the first chamber being adapted to be in fluid flow communication with the second chamber and the second chamber being adapted to be in fluid flow communication with the pouch;

a spout in fluid flow communication with the first chamber,

a first closing mechanism effective for allowing passage of a fluid from the first chamber to the spout when being in an open position and being effective for preventing passage of a fluid from the first chamber to the spout when being in a closed position; and

a second closing mechanism effective for allowing passage of a fluid from the first chamber to the second chamber when being in an open position and being effective for preventing passage of a fluid from the first chamber to the second chamber when being in a closed position.

According to another aspect, there is provided a pouring device for use with a pouch containing a liquid comprising:

a housing comprising walls defining a first chamber adapted to receive a liquid and a second chamber adapted to receive a liquid, the first chamber being adapted to be in fluid flow communication with the second chamber and the second chamber being adapted to be in fluid flow communication with the pouch;

a supporting member effective for securing the pouring device to a container adapted to receive the pouch, the supporting member being adapted to be mounted on the housing;

a first closing mechanism effective for allowing passage of a fluid from the first chamber to outside the pouring device when being in an open position and being effective for preventing passage of a fluid from the first chamber to outside the pouring device when being in a closed position; and

a second closing mechanism effective for allowing passage of a fluid from the first chamber to the second chamber when being in an open position and being effective for preventing passage of a fluid from the first chamber to the second chamber when being in a closed position.

According to another aspect, there is provided a pouring device for use with a pouch containing a liquid comprising:

a housing comprising walls defining a first chamber adapted to receive a liquid and a second chamber adapted to receive a liquid, the first chamber being adapted to be in fluid flow communication with the second chamber and the second chamber being adapted to be in fluid flow communication with the pouch;

a sealing mechanism for sealingly engaging the pouring device with the pouch;

a first closing mechanism effective for allowing passage of a fluid from the first chamber to outside the pouring device when being in an open position and being effective for preventing passage of a fluid from the first chamber to outside the pouring device when being in a closed position; and

a second closing mechanism effective for allowing passage of a fluid from the first chamber to the second chamber when being in an open position and being effective for preventing passage of a fluid from the first chamber to the second chamber when being in a closed position.

It was observed that by using such pouring devices, a user can considerably reduce the risks of spillage and premature oxidation of the liquid contained in the pouch. It is also possible to considerably reduce the risks of contamination of the liquid. In brief, it extends the period of time at which the freshness of the liquid is preserved. Moreover, the various flavors and aromas of the liquid are preserved over a prolonged period of time. These devices also provide interesting solutions for efficiently sealing a pouch for avoiding spillage and for efficiently securing the devices to a container adapted to receive the pouch.

### BRIEF DESCRIPTION OF THE DRAWINGS

In the appended drawings which represent various examples:

FIG. 1 is an exploded view of an example of a pouring device according to the present disclosure;

FIG. 2 is a side view of the pouring device shown in FIG. 1, wherein the pouring device is shown together with an optional supporting member illustrated on the left side of FIG. 2;

FIG. 3 is a cross-section view of the pouring device shown in FIG. 2 taken along the line 3-3;

FIG. 4 is a vertical cross-section view of the pouring device shown in FIG. 3, wherein the pouring device and the supporting member are connected together and wherein the supporting member is mounted on a portion of a container (broken line).

### DETAILED DESCRIPTION OF THE DISCLOSURE

The following examples are presented in a non-limitative manner.

The expression “substantially at right angle” as used herein means, for example an angle of about 75 to about 105°. It can also refer to an angle of about 80 to about 100° or about 85 to about 95°.

For example, the first closing mechanism can comprise a first cylindrical wall and a second cylindrical wall. Alternatively, the first closing mechanism can comprise a trap or door system. For example a slidable trap.

For example, the supporting member can comprise a first leg adapted to be disposed inside the container and a second leg adapted to be disposed outside the container.

For example, the sealing mechanism can comprise a bias element, a sleeve and a stop member that are slidably mounted on an exterior wall of the second chamber. The sleeve can be adapted to move between two positions: (i) a first position, whereat the bias element is compressed, thereby generating a space between the sleeve and the stop member for receiving and engaging a portion of the pouch; and (ii) a second position, whereat the bias element urges the sleeve against the stop member, thereby sandwiching the portion of the pouch between the sleeve and the stop member and sealingly engaging the portion of the pouch with the pouring device.

For example, the stop member can be an O-ring.

For example, the bias element can be a spring.

The second closing mechanism can comprise a ball valve and a seal. It can also comprise other types of valves such as a butterfly valve, a check valve, a gate valve, a globe valve, etc.

For example, the first chamber can be defined by the first cylindrical wall having a side wall and top portion and the second cylindrical wall having a side wall and a bottom portion, the cylindrical walls being each provided with at least one aperture in such a manner that when the apertures are at least partially aligned, passage of a fluid from the first chamber to outside the device is allowed and when the apertures are not aligned, passage of a fluid from the first chamber to outside the device is prevented.

For example, the first cylindrical wall and the second cylindrical wall can be rotatably mounted with respect to one another.

For example, the first cylindrical wall can be rotatably mounted on the second cylindrical wall, the first cylindrical wall having a diameter greater than a diameter of the second cylindrical wall.

For example, the second chamber can be defined by a third cylindrical wall, the third cylindrical wall comprising a first aperture allowing for the fluid flow communication with the first chamber and a second aperture allowing for the fluid flow communication with the pouch.

For example, the second closing mechanism can comprise a ball valve and a seal and the ball and the seal are dimensioned to block the first aperture in the closed position, thereby preventing passage of a fluid from the first chamber to the second chamber.

For example, the third cylindrical wall can have a diameter inferior to a diameter of the second cylindrical wall.

For example, the housing can be further provided with a piercing member having a portion adapted to pierce the pouch and allowing the device to be partially inserted therein, the piercing member being mounted on the third cylindrical wall, the piercing member comprising an inlet and an outlet for allowing a fluid flow communication between the second chamber and the pouch.

According to another aspect, there is provided a kit comprising at least one pouring device as previously described; and a container adapted to receive a pouch containing a liquid. The kit can also comprise instructions related to the use of the device and container.

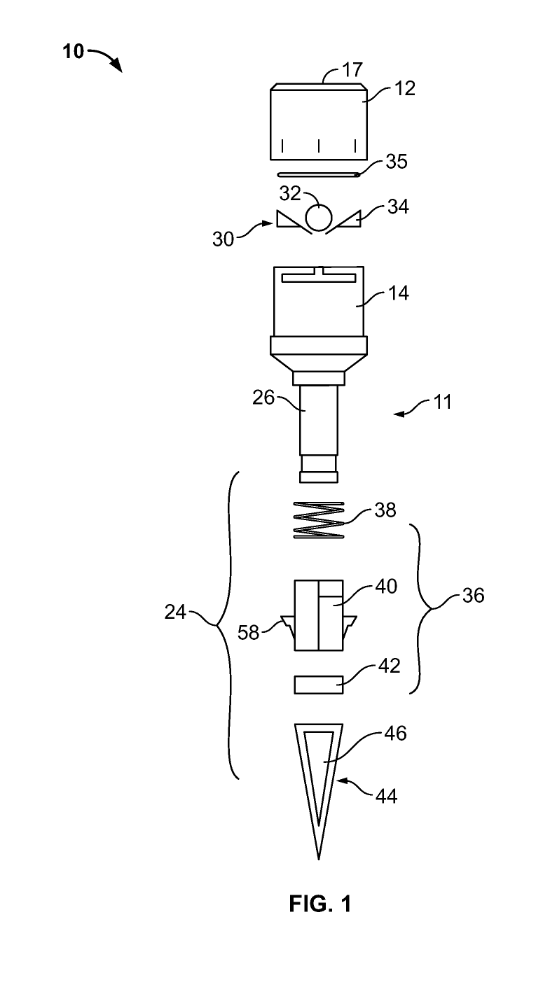

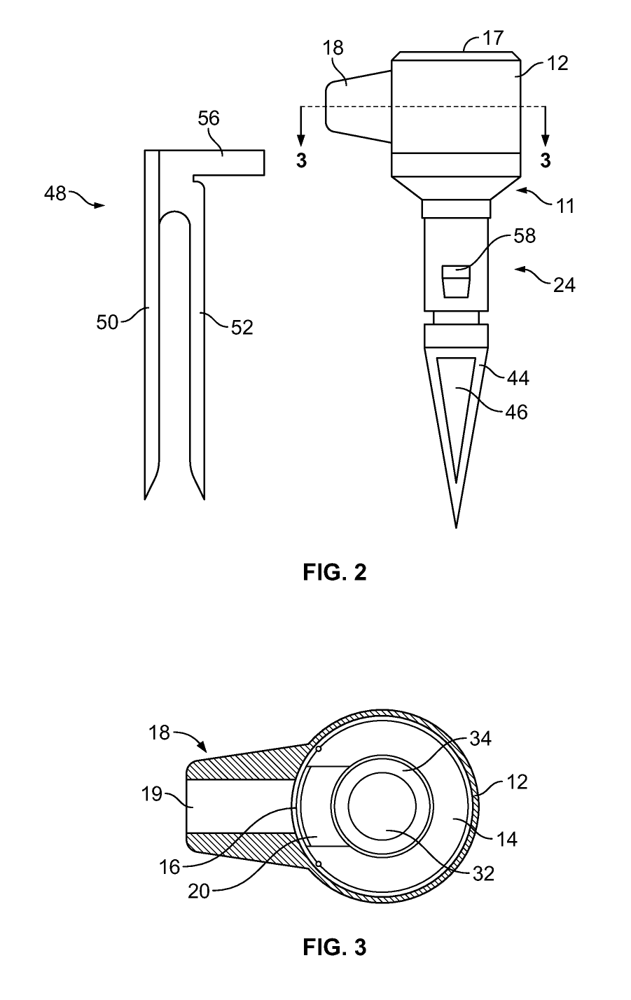

As it can be seen from FIGS. 1 to 4 a pouring device 10 is provided with a housing 11. More particularly, the housing 11 comprises a first cylindrical wall 12 and a second cylindrical wall 14. The first cylindrical wall 12 is provided with an aperture 16 and a top portion 17. The first cylindrical wall 12 also comprises a spout 18 which is in fluid flow communication with the aperture 16. The second cylindrical wall 14 is also provided with an aperture 20 and a bottom portion 21. The spout 18 comprises a pouring portion 19 radially outwardly extending from the device 10. The pouring portion is extending at substantially a right angle from the housing 11 which facilitates pouring a liquid therethrough.

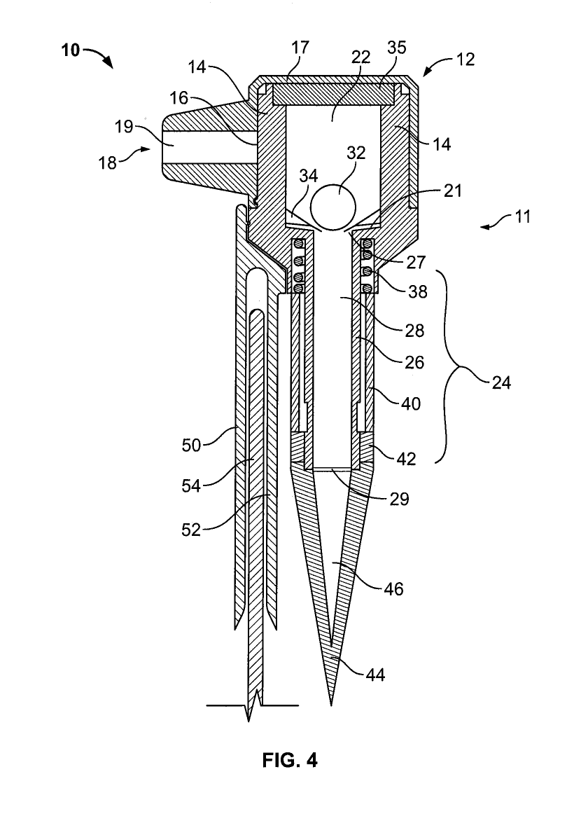

As it can be seen from FIG. 4, the first cylindrical wall 12 and the second cylindrical wall 14, when connected together, define a first chamber 22.

As it can be seen from FIG. 1, the device 10 can also be used without the first cylindrical wall 12 and without the ball valve 30 for other purposes. In fact, if a user wants to fill a pouch with a liquid, the device 10 having the wall 12 and the valve 30 removed can be used as a funnel for filling a pouch. When using it in such a configuration, the aperture 20 of the second cylindrical wall can be blocked with any suitable piece of a material dimensioned for blocking this aperture.

The pouring device 10 comprises a body portion 24. The body portion comprises a third cylindrical wall 26 which defines a second chamber 28. The third cylindrical wall 26 further comprises an aperture 27 and an aperture 29 that allow for a fluid to be conveyed therethrough. The aperture 27 allows for a fluid flow communication between the first chamber 22 and the second chamber 28 while the aperture 29 allows for a fluid flow communication between the second chamber 28 and the interior of the pouch.

When connected together, the first cylindrical wall 12 and the second cylindrical wall 14 constitute a first closing mechanism which prevents passage of a fluid from the first chamber 22 to the exterior of the pouring device 10 and also prevent a fluid from the exterior of the device from entering into the chamber. When the first cylindrical wall 12 and the second cylindrical wall 14 are rotated with respect to one and another at certain positions, the aperture 16 matches with the aperture 20 thereby allowing fluid flow communication between the first chamber 22 and the spout 18 and allowing a fluid contained in the first chamber 22 to flow through aperture 16, aperture 20 and spout 18 to be poured outside of the device 10.

In FIG. 3, the aperture 16 is aligned with the aperture 20 so as to allow the passage of a fluid.

The pouring device stand is also provided with a second closing mechanism comprising a ball valve 30. The ball valve 30 comprises a ball 32 and a first seal 34. The ball valve 30 is effective, in a position as shown in FIG. 4, to prevent a fluid flow communication between the first chamber 22 and the second chamber 28 by blocking the aperture 27. However, when, for example, the device 10 is in another position (for example, tilted or inclined) the ball 32 is displaced from the aperture 27, thereby allowing a fluid flow communication between the first chamber 22 and the second chamber 28. The device can also comprise a second seal 35 adapted to be disposed below the top portion 17.

The pouring device 10 also comprises a sealing mechanism 36 which comprises a bias element 38, a sleeve 40 and a stop member 42. The bias element 36, the sleeve 40 and the stop member 42 are all dimensioned to be mounted on the third cylindrical wall 26 in such a sequential order. The sealing mechanism 36 allows for sealingly engaging a pouch containing a liquid so that when a liquid flows from the pouch to the pouring device 10, there is no spills or liquid leaking at the junction of the pouch and the device 10. The sealing mechanism 36 thus sealingly engage the pouch. More particularly, when all the three elements 38, 40 and 42 of the sealing mechanism 36 are mounted on the third cylindrical wall 26, the bias element 38 urges the sleeve 40 against the stop member 42 (first position or closed position). A user desirous of sealingly engaging the pouch with the pouring device 10 simply has to compress the bias element 38 by sliding the sleeve 40 (second position or open position) towards the bias element 38 thereby generating a space between the sleeve 40 and stop member 42. Such space is thus adapted to receive the pouch. When the pouch is inserted in the space between the sleeve 40 and the stop member 42, the user simply needs to release the sleeve 40 that will be back at such a first position and sealingly engage the pouch.

In an embodiment, the stop member 42 is an O-ring. As can be seen on FIG. 1, the sleeve 40 can present ridges 58 or a portion presenting a certain friction such as an anti-skid material for facilitating movement of the sleeve by the user.

The bias element 38, the sleeve 40 and the stop member 42 can all have a general cylindrical shape and be provided with a diameter that is superior to the diameter of the third cylindrical wall 26. The pouring device 10 can be further be provided with a piercing member 44 that is adapted to pierce the pouch and allow for partially inserting the device 10 into the pouch before sealingly engaging the pouch with sealing mechanism 36. The piercing member 44 is provided with at least an aperture 46 to allow a fluid flow communication between the pouch and the second internal chamber 28.

As it can be seen in FIGS. 3 and 4, a pouring device 10 can be further provided with a supporting member 48 which comprises a first leg 50 and a second leg 52. The legs 50 and 52 are adapted to receive a portion 54 of a container (for example a jug) that is adapted to receive the pouch. The leg 50 is thus disposed outside the portion 54 of the container and the leg 52 is disposed inside the container. The supporting member 48 is also provided with a connector 56 for releasably mounting the supporting member 48 on the housing 11 of the device 10. For example, the connector 56 can be a clip, a pressure clip, a pin, etc. A matching portion of the housing 11 is thus adapted to receive such a connector 56.

The pouring device 10 is effective for pouring a fluid contained in a pouch such a milk, juice etc. The enclosed liquid is poured out of a spout 18 via the pouring portion 19. When comprising a supporting member 48, the device 10 can be connected to a portion 54 of a container (for example a jug). Such container is adapted to receive a pouch containing a liquid and can be made of plastic or metal. Such container can further comprise a handle to facilitate manipulation by the user.

A user having a pouch comprising a liquid that can be inserted into a container can use the pouring device 10 by first piercing an aperture into the pouch by using the piercing member 44. Then, the user can insert the pouring device 10 into the aperture of the pouch and sealingly engage the pouch together with the pouring device 10 by using the sealing mechanism 36 as previously explained. By doing so, the user will avoid any spillage and having a liquid leaking from the junction of the device 10 and the pouch. Optionally, if the device 10 is provided with a support member 48, the device 10 can be secured to the container by using the support mean 48. In fact, by simply placing the leg 50 outside the container and the leg 52 inside the container, the user will thus secure the device 10 to the container. When the user is ready to pour the liquid out of the pouch, the later can simply rotate the first cylindrical wall 12 so as to make sure that the aperture 16 and the aperture 20 are at least partially aligned and then, the container can be tilted so as to pour the liquid. By doing so, the user will cause the ball 32 to move inside the first chamber 22 and thereby provide a free access to the aperture 27 which will no longer be blocked by the ball 32. The liquid will thus flow through the aperture 46, the aperture 29, the second chamber 28, the aperture 27, the first chamber 22, the aperture 20, the aperture 16, and the pouring portion 19. Once the liquid is poured, the user can put back the container at a vertical position whereat the ball 32 is blocking the aperture 27. Any remaining liquid in the first chamber 22 would then be prevented from returning into the second chamber 28 and eventually into the pouch. When a certain portion of liquid is maintained in the first chamber 22, the user can simply slightly tilt the container so as to remove this portion from the first chamber 22. Also, by slightly tilting the container, the user can disengage the ball 32 from the aperture 27 and eventually compress the pouch so as to substantially remove the air contained within the pouch and the device 10. When such a step is completed, the user can simply rotate the first cylindrical wall 12 so as to make sure that the aperture 16 and the aperture 20 do not match with one and another and eventually to put back the container into a vertical position thereby positioning the first closing mechanism and the second closing mechanism into closed positions. In such positions, any fluid disposed outside of the pouring device is prevented from entering into the first chamber 22 and into the second chamber 28. Such closed positions can be maintained until a user wants to pour a further quantity of liquid.

For example, when using the device 10 to pour a liquid enclosed in the pouch, the container holding the pouch can be slightly tilted thereby allowing the liquid to flow through the second chamber 28, the first chamber 22 and eventually through the spout 18. When such a step is completed, the container can be brought back to its original vertical position. The liquid remaining in the pouring device 10 will either fall back into the liquid pouch, if comprised in the second chamber 28, or be trapped in the first chamber 11 by way of the first closing mechanism.

When the ball 32 is placed at the center of the seal 34, the ball closes the aperture 27 and therefore prevents any communication between the first chamber 22 and the second chamber 28. Indeed, when the ball 32 covers the aperture 27 located at the bottom of the seal 34, substantially no fluids (such as liquid, air, gas) or contaminants can be transferred from the first chamber 22 to the second chamber 28. Indeed, by blocking the aperture 27, the ball valve 30 prevents any bacteria or spore from contacting the liquid enclosed in the pouch or second chamber 28. This second closing mechanism therefore allows to maintain the sterility of the enclosed liquid. To unlock the second closing mechanism, a simple tilting of the pouring device 10 is required. Indeed, the ball 32 will roll away from the aperture 27 when tilting the container, which will therefore unblock the passage between the two chambers 22 and 28.

The first chamber 22 is defined by a first cylindrical wall 12 and a second cylindrical wall 14 By rotating the first and second wall with respect to one another, the user can align both apertures (16 and 20) with one another. This allows for pouring out the liquid enclosed in the first chamber 22. Subsequently, when a user has finished pouring the liquid and has brought the container back into a vertical position, the first cylindrical wall 12 and the second cylindrical wall 14 can be rotated again to un-align the apertures 16 and 20 and therefore prevent any liquid from entering or exiting the first chamber 22 towards the outside of the device 10. This rotating system represents the first closing mechanism of the pouring device 10. It has the advantage of preventing fluids (liquid, air, gas) or contaminants from entering into the first chamber 22. It therefore prevents any bacteria or spore from entering the first chamber 22 and helps to maintain the freshness and integrity of the enclosed liquid.

The present disclosure has been described with regard to specific examples. The description was intended to help the understanding of the disclosure, rather than to limit its scope. It will be apparent to one skilled in the art that various modifications may be made to the disclosure without departing from the scope of the disclosure as described herein, and such modifications are intended to be covered by the present document.

1. A pouring device for use with a pouch containing a liquid comprising:
a housing comprising walls defining a first chamber adapted to receive a liquid and a second chamber adapted to receive a liquid, said first chamber being adapted to be in fluid flow communication with said second chamber and said second chamber being adapted to be in fluid flow communication with said pouch;
a spout in fluid flow communication with said first chamber, said spout comprising a pouring portion extending radially outwardly and substantially at right angle from said housing;
a first closing mechanism comprising a first cylindrical wall and a second cylindrical wall, said first closing mechanism being effective for allowing passage of a fluid from said first chamber to said spout when being in an open position and being effective for preventing passage of a fluid from said first chamber to said spout when being in a closed position; and
a second closing mechanism effective for allowing passage of a fluid from said first chamber to said second chamber when being in an open position and being effective for preventing passage of a fluid from said first chamber to said second chamber when being in a closed position.

2. A pouring device for use with a pouch containing a liquid comprising:
a housing comprising walls defining a first chamber adapted to receive a liquid and a second chamber adapted to receive a liquid, said first chamber being adapted to be in fluid flow communication with said second chamber and said second chamber being adapted to be in fluid flow communication with said pouch;
a supporting member effective for securing said pouring device to a container adapted to receive said pouch, said supporting member being adapted to be mounted on said housing;
a first closing mechanism effective for allowing passage of a fluid from said first chamber to outside said pouring device when being in an open position and being effective for preventing passage of a fluid from said first chamber to outside said pouring device when being in a closed position; and
a second closing mechanism effective for allowing passage of a fluid from said first chamber to said second chamber when being in an open position and being effective for preventing passage of a fluid from said first chamber to said second chamber when being in a closed position.

3. The device of claim 2, wherein said supporting member comprises a first leg adapted to be disposed inside said container and a second leg adapted to be disposed outside said container.

4. A pouring device for use with a pouch containing a liquid comprising:
a housing comprising walls defining a first chamber adapted to receive a liquid and a second chamber adapted to receive a liquid, said first chamber being adapted to be in fluid flow communication with said second chamber and said second chamber being adapted to be in fluid flow communication with said pouch;
a sealing mechanism for sealingly engaging said pouring device with said pouch;
a first closing mechanism effective for allowing passage of a fluid from said first chamber to outside said pouring device when being in an open position and being effective for preventing passage of a fluid from said first chamber to outside said pouring device when being in a closed position; and
a second closing mechanism effective for allowing passage of a fluid from said first chamber to said second chamber when being in an open position and being effective for preventing passage of a fluid from said first chamber to said second chamber when being in a closed position.

5. The pouring device according to claim 4, wherein said sealing mechanism comprises a bias element, a sleeve and a stop member that are slidably mounted on an exterior wall of said second chamber, said sleeve being adapted to move between two positions: (i) a first position, whereat said bias element is compressed, thereby generating a space between said sleeve and said stop member for receiving and engaging a portion of said pouch;
and (ii) a second position, whereat said bias element urges said sleeve against said stop member, thereby sandwiching said portion of said pouch between said sleeve and said stop member and sealingly engaging said portion of said pouch with said pouring device.

6. The device of 5, wherein said stop member is an O-ring and said bias element is a spring.

7. The pouring device according to claim 1, wherein said second closing mechanism comprises a ball valve and a seal.

8. The pouring device according to claim 1, wherein said second closing mechanism comprises a ball valve and a seal.

9. The pouring device according to claim 2, wherein said second closing mechanism comprises a ball valve and a seal.

10. The pouring device according to claim 4, wherein said second closing mechanism comprises a ball valve and a seal.

11. The pouring device of claim 4, wherein said first closing mechanism comprises a first cylindrical wall and a second cylindrical wall.

12. The device of claim 11, wherein said first chamber is defined by said first cylindrical wall having a side wall and top portion and said second cylindrical wall having a side wall and a bottom portion, said cylindrical walls being each provided with at least one aperture in such a manner that when said apertures are at least partiallly aligned, passage of a fluid from said first chamber to outside said device is allowed and when said said apertures are not aligned, passage of a fluid from said first chamber to outside said device is prevented.

13. The device of claim 12, wherein said first cylindrical wall and said second cylindrical wall are rotatably mounted with respect to one another.

14. The device of claim 11, wherein said first cylindrical wall is rotatably mounted on said second cylindrical wall, said first cylindrical wall having a diameter greater than a diameter of said second cylindrical wall.

15. The device of claim 11, wherein said first cylindrical wall is rotatably and releasably mounted on said second cylindrical wall, said first cylindrical wall having a diameter greater than a diameter of said second cylindrical wall, when said first cylindrical wall is removed as well as said second closing mechanism, said device can be used as a funnel for filling a pouch.

16. The device of claim 11, wherein said second chamber is defined by a third cylindrical wall, said third cylindrical wall comprising a first aperture allowing for said fluid flow communication with said first chamber and a second aperture allowing for said fluid flow communication with said pouch.

17. The device of claim 16, wherein said second closing mechanism comprises a ball valve and a seal and said ball and said seal are dimensioned to block said first aperture in said closed position, thereby preventing passage of a fluid from said first chamber to said second chamber.

18. The device of claim 16, wherein said third cylindrical wall has a diameter inferior to a diameter of said second cylindrical wall.

19. The device of claim 3, wherein said housing is further provided with a piercing member having a portion adapted to pierce said pouch and allowing said device to be partially inserted therein, said piercing member being mounted on said third cylindrical wall, said piercing member comprising an inlet and an outlet for allowing a fluid flow communication between said second chamber and said pouch.

20. A kit comprising:
at least one pouring device as described in claim 4; and
a container adapted to receive a pouch containing a liquid.
